(19) United States
(12) Patent Application Publication
(10) Pub. No.: US 2019/0298083 A1
(43) Pub. Date: Oct. 3, 2019

(54) A POWERED SHELVING ARRANGEMENT

(71) Applicant: Lighting Spaces Australia Pty Ltd, Bayswater (AU)

(72) Inventors: Joshua Huang Min Lee, Blackburn North (AU); Jerry Wei Kong Lee, Dandenong (AU); Chung Ming Chuo, St. Kilda (AU)

(21) Appl. No.: 16/317,356

(22) PCT Filed: Jun. 28, 2017
(86) PCT No.: PCT/AU2017/050659

§ 371 Date: Jan. 11, 2019

(30) Foreign Application Priority Data
Jul. 13, 2016 (AU) 2016902754
Mar. 21, 2017 (AU) 2017901000

(51) Int. Cl. A47F 3/00; A47F 11/10; F21V 21/35; F21V 23/06

(52) U.S. Cl. CPC A47F 3/001; A47F 11/10; F21W 2131/405; F21V 23/06; F21V 21/35

(57) ABSTRACT

A furniture structure including: one or more generally vertical side panels; one or more shelf boards configured to extend from the one or more side panels; two electrical conductors coupled to a side panel of the furniture structure, to receive electrical power of differing polarity from a power supply; an electrical component coupled to a shelf board, wherein said electrical component includes two power terminals located at one end of the electrical component, the power terminals being accessible from a side surface of the shelf board; and wherein the electrical power is supplied to the electrical component via a direct physical contact between the power terminals of the electrical component and the two electrical conductors.

### FIELD OF THE INVENTION

The present disclosure relates to a powered shelving arrangement for storing, displaying or presenting goods in a residential, office, commercial or retail environment.

It may find particular, though not exclusive, application in powering an illumination device in the shelving arrangement integrated into a furniture structure.

### BACKGROUND OF THE INVENTION

A furniture structure such as a display wall, cabinet, or cupboard is widely used for storing, displaying or presenting goods in a residential, office, commercial or retail environment. Some of these furniture structures are designed to include illumination devices disposed at various locations on or in the furniture structure to help provide additional lighting. The illumination devices may be installed in shelves.

In a commercial setting, illuminated furniture structures can help improve the aesthetic appeal of the goods being displayed. The additional lighting also allows details of the goods presented to be more easily inspected especially when the surrounding environment is dark. In a residential setting, illuminated furniture structures may be used to light internal spaces such as wardrobes, cabinets, kitchen shelves and pantry shelves.

Providing electrical power connection to the lighting units can be a time consuming task. An electrician is generally needed to run electrical wiring from a power source to the lighting units. The electrician or the installers also need to carefully conceal the wires so that the wires do no adversely impact the aesthetic appeal of the furniture structure. The installation task can get very time consuming and costly as the number of lighting units increase. As such, scalability of such systems is often poor. In addition, if electrical wires are not connected or concealed properly, live wires can be exposed, which can result in serious injury if touched.

Once the shelves and the lighting units are fixed in place, the shelves may not be easily relocated to different locations as a licensed electrician is again required to disconnect and then reconnect all the electrical wiring again. In many shelving systems it can be quite difficult to adjust the position of a shelf. However, it is desirable that an end user is able to readily adjust shelving themselves.

It would therefore be desirable to provide an illuminated structure that is easy to install. It is also desirable that the electrical connections for powering the illumination devices do not detract from the aesthetical appeal of the furniture structure.

It is therefore an object of the present disclosure to provide a powered shelving arrangement that aims to ameliorate at least some of the problems mentioned above, or to at least provide an alternative choice for the general public.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the invention includes a powered shelving arrangement comprising:
at least two spaced apart electrically conductive power rails, wherein each power rail in a pair is configured to receive electrical power of differing or opposing polarity;
one or more shelf boards supported by the power rails, wherein at least one of the one or more shelf boards includes a pair of electrically conductive extension arms for coupling to the power rails; and
one or more electrical components, wherein said coupling between the extension arms and the power rails allows electrical power to flow across the power rails and the extension arms to power the electrical components.

In one form, each power rail may be part of a power rail assembly that includes two electrically conductive rails with an insulating layer physically joining and thermally separating the rails, the two rails each being configured to connect to an electrical power supply of differing or opposing polarity.

In one form, the distance between the pair of extension arms of a shelf board is substantially the same as the distance between pairs of power rails that are configured to connect to electrical power supply of differing or opposing polarity.

In one form, a power adaption device is included to convert a power source to a suitable voltage level before connecting to the power rails.

In one form, a power rail assembly includes two aluminium extrusions and a non-conductive insulation layer is provided between the aluminium extrusions as the insulation layer. Preferably, the aluminium extrusions comprise a lengthwise channel and a fixing portion such as a flange for attaching to a supporting structure such as a wall.

In one form, the extension arms are removably coupled to the power rails.

In one form, the extension arms are metal brackets that run adjacent the opposing side surfaces of a shelf board. Preferably the extension arms include engagement portions for coupling to the power rails. In one form, the engagement portions include one or more tabs or tangs and the power rails include one or more openings for receiving the engagement portions of the extension arms.

Preferably, the shelf board is made of substantially non-conductive or insulating material. In one form, the shelf board includes one or more preformed channels arranged to receive the electrical components.

Preferably, the electrical components are lighting units that are disposed at a lower surface of a shelf board. In one form, at least one of the lighting units is an LED lighting strip that includes metal caps at opposing ends of the lighting strip.

In one form, the shelving arrangement includes a plurality of power rails or power rail assemblies and the power rails are separated at an equal parallel distance apart.

In a second aspect, the invention includes a shelving arrangement comprising:
at least two spaced apart electrically conductive power rails, wherein each power rail in a pair is configured to receive electrical power of differing or opposing polarity;
one or more shelf boards supported by the power rails, wherein at least one of the one or more shelf boards includes one or more electrical components, said electrical components being in electrical connection with the pair of power rails so as to be powered by the electrical power that flows through the power rails.

Preferably, the electrical components are lighting units that are disposed at a lower surface of a shelf board.

In a third aspect, the invention includes a powered shelving arrangement comprising:
a pair of electrical conductors configured to be coupled to a generally vertical side panel of a supporting structure, wherein said electrical conductors are each configured to receive electrical power of differing polarity from a power supply; at least one shelf board configured to extend from the generally vertical side panel;
an electrical component coupled to the shelf board and configured to receive the electrical power from the pair of electrical conductors, wherein said electrical component includes two power terminals located at one end of the electrical component, the power terminals being accessible from a side surface of the shelf board; and
the electrical power is supplied to the electrical component via a physical contact between the power terminals of the electrical component and the pair of electrical conductors.

In a fourth aspect, the invention includes a furniture structure including: one or more generally vertical side panels;
one or more shelf boards configured to extend from the one or more side panels;
two electrical conductors coupled to a side panel of the furniture structure, to receive electrical power of differing polarity from a power supply;
an electrical component coupled to a shelf board, wherein said electrical component includes two power terminals located at one end of the electrical component, the power terminals being accessible from a side surface of the shelf board; and
wherein the electrical power is supplied to the electrical component via a direct physical contact between the power terminals of the electrical component and the two electrical conductors.

Preferably, the two electrical conductors are arranged side by side but separated apart by a parallel distance to avoid short circuiting between the electrical conductors.

In one form, the electrical conductors may be a pair of thin metal strips coupled to a side surface of the side panel from which the shelf board extends.

In one form, the electrical conductors may form part of a power rail assembly. The power rail assembly may be provided in a modular form and include a non-conductive insulation layer electrically separating the two electrical conductors.

In another form, the electrical conductors may be provided as part of a flexible conductive tape. The conductive tape includes a non-conductive substrate material, wherein the pair of conductors is attached to or integrated into to the substrate material. The conductive tape can also include an adhesive means provided on one surface for easy coupling to a surface of the side panel.

In one form, the electrical conductors may extend a substantial vertical height of the side panel to provide multiple power tap-off points for a plurality of electrical components each coupled to a different shelf board of the furniture structure.

In a preferred form, the side panel includes two pre-formed parallel channels or recesses to receive the respective electrical conductors.

In another form, the side panel may include a single pre-formed channel to receive a modular power rail assembly or a conductive tape.

The electrical conductors are arranged to be electrically connected to the power supply by any suitable means.

Preferably, the electrical component is an illumination device that is disposed at a lower surface of the shelf board to illuminate the space directly below or adjacent the vicinity of the shelf board.

In one form, the shelf board includes a preformed complementary channel or recess configured to receive the electrical component.

In a more preferred form, the illumination device is an elongate LED lighting component that extends along the width of the shelf board. The lighting component includes an elongate body portion and two opposing ends, wherein the two power terminals are located at one end of the elongate body portion and extend outwardly from a side surface of the shelf board after the lighting component is coupled to the shelf board.

In one form, the power terminals are provided in the form of two spaced-apart metal caps. In a preferred form, the power terminals are arranged to protrude or bulge slightly from the side surface of the shelf board so that the power terminals are biased against the electrical conductors once the shelf board including the lighting component is installed relative to the side panel(s).

In one form, the shelf board is at least partially or entirely supported by the side panels to extend in a generally horizontal direction.

Preferably, the physical contact between the power terminals of the electrical component and the electrical conductors is not weight bearing.

Preferably, the side panels and the one or more shelf boards are made of a substantially non-conductive or insulating material.

In a fifth aspect, the invention includes a furniture structure comprising:
a pair of generally vertical planar side panels;
one or more shelf boards arranged to extend in a horizontal direction between the planar side panels;
a pair of electrical conductors coupled to one of the side panels and extending in a generally vertical direction, wherein the pair of electrical conductors are arranged to receive electrical power of differing polarity from a power supply;
an electrical component coupled to one of the shelf boards, wherein said electrical component includes two power terminals located at one end of the electrical component, the power terminals being accessible from a side surface of the shelf board and being arranged to form a direct physical and electrical contact with the respective electrical conductors to receive electrical power therefrom.

In a sixth aspect, the invention provides a power device for a shelving arrangement, said power device being configured to provide electrical power to an electrical component of the shelving arrangement, wherein the power device includes:
a flexible substrate made of a non-conductive material;
a pair of electrical conductors supported by the flexible substrate, wherein said electrical conductors are each configured to receive electrical power of differing polarity from a power supply to thereby operate the electrical component of the shelving arrangement.

In one form, the power device is provided in the form of a tape wherein the electrical conductors are provided on one surface of the tape. The tape may also include an adhesive material on another surface so that the tape can be attached to a suitable supporting structure of the shelving arrangement.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE DRAWINGS

Further aspects of the present invention and further embodiments of the aspects described in the preceding paragraphs will become apparent from the following description, given by way of example and with reference to the accompanying drawings, in which:

FIG. 1 is a perspective view of a shelving arrangement in accordance with one embodiment of the present invention;

FIG. 2 shows a front view of another illustrative shelving arrangement according to an embodiment of the invention;

FIG. 3 shows a perspective view of a power rail assembly;

FIG. 4 shows a side view of an extension arm coupled to a power rail;

FIG. 5 shows another perspective view of a power rail assembly installed in a backing board;

FIG. 6 shows a front view of a power rail assembly;

FIG. 7 shows an embodiment of an assembled shelf;

FIG. 8 is a cross-sectional side view of a shelf board;

FIG. 9 is a perspective side view of a lighting unit;

FIG. 10 shows a mechanism of tapping power on to a power rail;

FIG. 11 shows an alternative embodiment of a shelving arrangement installed in cabinetry;

FIG. 12 is a perspective view of a furniture structure in accordance with one embodiment of the present invention;

FIG. 13 illustrates details of the electrical connection between a pair of electrical conductors and an electrical component of the furniture structure;

FIG. 14a shows the direction of the electrical power flow from a main power source to the electrical component;

FIG. 14b shows a cross sectional top view of an exemplary side panel across its width;

FIG. 14c shows a side perspective view of an exemplary embodiment of a power rail assembly including two electrical conductors;

FIG. 14d shows a cross sectional top view of another exemplary embodiment of a side panel across its width;

FIG. 15 shows a perspective view of an exemplary embodiment of a conductive tape including two electrical conductors;

FIG. 16 shows a side perspective view of a furniture structure with an exemplary cover component;

FIG. 17 shows a perspective bottom view of a shelf board;

FIG. 18 shows a perspective side view of an exemplary electrical component; and

FIG. 19 shows a side view of an exemplary electrical component.

### DETAILED DESCRIPTION OF THE EMBODIMENTS

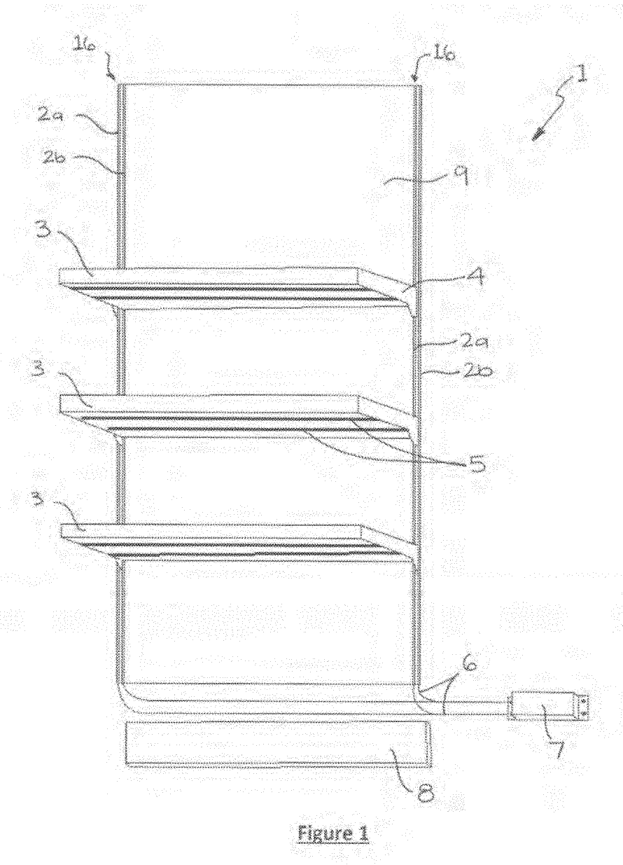

Referring to FIG. 1, a first illustrative embodiment of the present invention is shown by way of a vertically arranged shelving arrangement 1. The arrangement includes a backing board 9 that may be attached to a supporting structure such as a wall, or may be configured as a free standing display.

The shelving arrangement 1 includes two power rails assemblies 16 separated a parallel distance apart and extending generally vertically. A plurality of shelf boards 3 are supported by the power rail assemblies at varying height levels. One or more electrical components are coupled to the shelf boards 3. In the embodiment illustrated, the electrical components are lighting units 5 that provide lighting for the shelving arrangement 1. A pair of extension arms 4 are coupled to opposing side surfaces 15 (see FIG. 8) of each shelf board 3. The extension arms 4 are mounting brackets that support the shelf boards 3 to extend forwardly from the power rail assemblies.

In accordance with the invention, electrical power that is required to operate the lighting units 5 originates from a power source and flows to the lighting units 5 via the supporting structure of the shelving arrangement 1. This is due to components of the supporting structure being electrically conductive. This includes the power rails and the side extension arms 4 that are coupled to the power rails. As the power rails and the extension arms 4 are made from electrically conductive material, they provide both mechanical support and electrical conductivity. Therefore, additional electrical wiring can be greatly reduced or eliminated. This makes installation of the shelving arrangement 1 a much easier task.

The coupling between the power rail assemblies 16 and the side extension arms 4 is both mechanical and electrical in nature. Mechanical coupling enables the side extension arms 4 to be physically supported by the power rail assemblies. Electrical coupling is enabled when mechanical coupling is formed and it allows electrical power to flow within and across the power rails and the extension arms 4 to thereby operate the lighting units 5. The lighting units 5 are in electrical contact with the side extension arms 4. In one form, the electrical contact between the lighting units 5 and the side extension arms 4 is achieved by connecting wires or other forms of conductors (not shown) of the lighting units 5 to the extension arms 4. In a simplest example, each lighting unit 5 may include two end caps that form an electrical connection with the extension arms 4 as will be explained below.

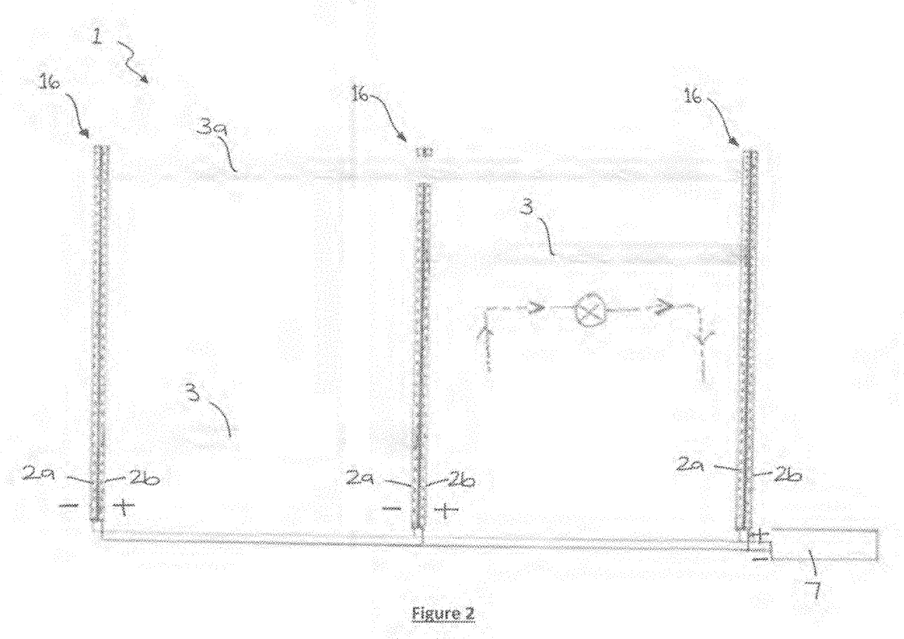

Also according to an aspect of the invention, the shelving arrangement 1 is configured so that each power rail assembly 16 includes two adjacent power rails 2a, 2b. Each power rail 2a, 2b in a pair receives electrical power of differing polarity. In one form, a power rail assembly 16 includes a left rail 2a and a right rail 2b. Differing polarity means a positive and a negative power connection, or a positive and a ground power connection. In FIG. 2, left rail 2a receives a negative polarity, whilst right rail 2b receives a positive polarity. A power adaption device 7 provides both positive and negative power supply to each rail assembly 16, with the positive power supply always being provided to the left rail 2a of each rail assembly 16 and the negative power supply being provided to the right rail 2b of each rail assembly 16.

As the shelving arrangement 1 is configured to allow electrical power to flow within the supporting structure, e.g. the power rails 2a, 2b and the extension arms 4, it is important to avoid any chance of accidently creating a short circuit between these components. As such, the shelf boards 3 and their corresponding extension arms 4 are dimensioned to span the distance between spaced apart left and right power rails 2a, 2b, connecting to differing electrical polarity. These left and right rails could be any two left and right rails 2a and 2b of any two adjacent power rail assemblies. For example FIG. 2 shows a configuration where two shelf boards 3 and their corresponding extension arms are dimensioned to couple to the inner rails 2b, 2a of the two adjacent power rail assemblies. If required, the length of a shelf board 3a may span across two non-adjacent power rail assemblies 16, for example being double the length of two adjacent spaced rails, as shown in FIG. 2. In this way, the shelf boards 3a can have predetermined set length dimensions, making manufacturing of such shelf boards easier. In a preferred embodiment, the distance between any two spaced power rails 2a, 2b is fixed and equal. The shelf boards 3 and their extension arms 4 are configured to span precisely the distance of the inner portions of any two adjacent spaced power rails 2a, 2b.

Once all the electrical contact between components is made, electricity can flow from one power rail 2b to the adjacent spaced power rail 2a via the arms 4 and the lighting units 5 supported by these two power rails 2a, 2b, creating a circuit loop such as that shown in FIG. 2. As indicated by the arrows, electrical power flows from a positively powered rail 2b to an adjacent negatively powered rail 2a via the extension arms 4 and the lighting units 5. This embodiment advantageously prevents an installer from accidently connecting two ends of a lighting unit to the same electrical polarity.

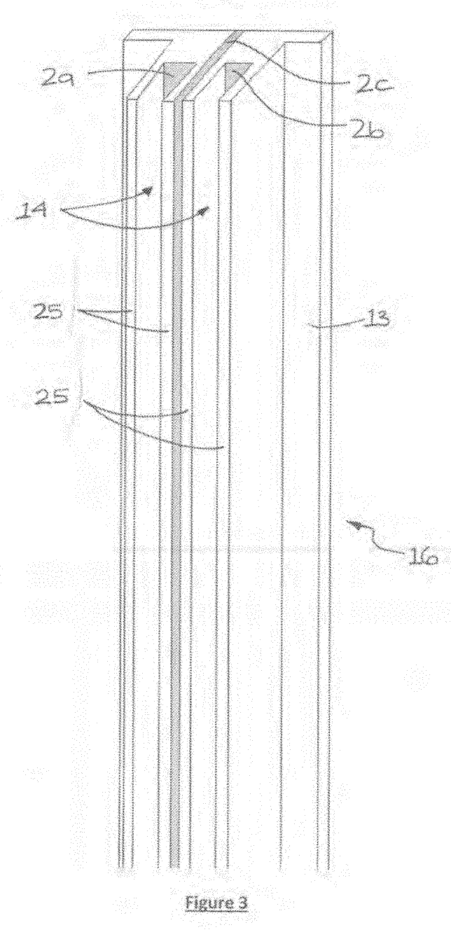

FIG. 3 shows the structural details of a rail assembly 16 that includes two rails: left rail 2a and right rail 2b. Both rails 2a and 2b are made of electrically conductive material such as metal, and also an electrically insulating layer 2c thermally and physically separating the left and right conductive rails. As mentioned above, the left and right rails 2a and 2b are each coupled to a power source of differing polarity, so that there is always a potential difference between the rails. The insulating layer 2c is provided to prevent accidental short-circuiting between the left and right rails 2a and 2b. In a simplest form, a power rail assembly 16 comprises two profiled aluminium extrusions. The two aluminium extrusions are arranged side by side and an adhesive layer is provided between the extrusions to act as the insulation layer and also provides the mechanical coupling between the rails 2a, 2b to create the power rail assembly 16.

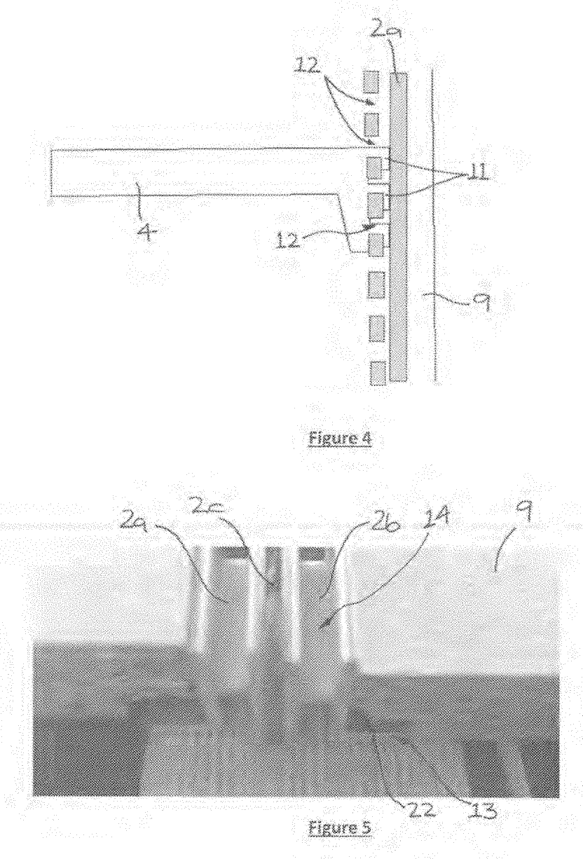

As shown best in FIG. 3, the left and right portions of a power rail each includes a channel 14 that extends a length of the rail for accepting the engagement portion 11 of the extension arms 4. The channels 14 are preferably front facing and are formed by a pair of walls 25 that are substantially parallel to each other. The series of openings 12 are formed within the channels 14, which are separated at regular intervals apart along the length of the channel 14 (see FIG. 4). The mechanical and electrical coupling arrangement between the power rails and the extension arms 4 may be in any suitable form as one would appreciate. In addition, the extension arms 4 are removably and adjustably fixed to the supporting power rails to allow positions of the shelf boards 3 to be adjusted if needed. FIG. 4 shows a side cross-sectional view of a coupling arrangement between an extension arm 4 and a power rail 2a. The extension arms 4 may each include a rear engagement portion including tangs or tabs 11 with downwardly extending hook portions that can be inserted into respective openings 12 in a power rail. This creates a mechanical coupling, as well as making the required electrical contact between the two components. As both the extension arms 4 and the power rails 2a, 2b are made of electrically conductive material, once the extension arms 4 are inserted and fixed relative to the power rails 2a, 2b, electrical contact is also made and electrical power can then flow within and across the components. Preferably the tabs 11 insert into the openings 12 and securely fix the extension arms 4 in place relative to the power rails 2a, 2b. If the position of the extension arms 4 needs to be adjusted, a person can simply lift the extension arms 4 upwardly and then pull the arms out from the openings 12.

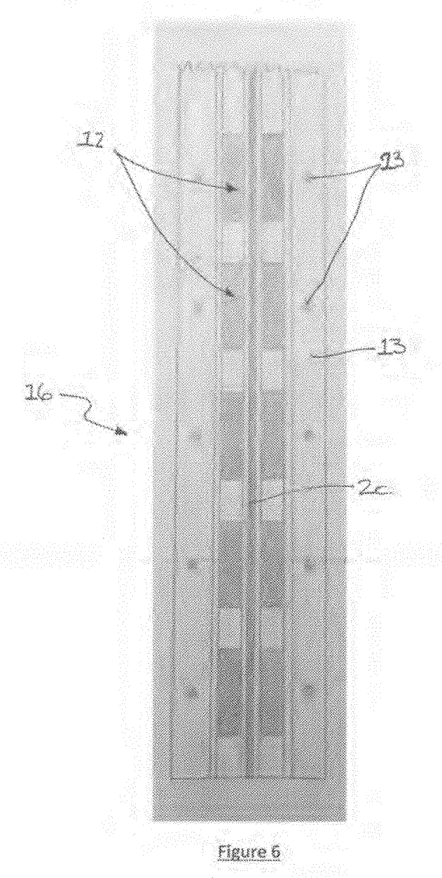

As previously mentioned, in one embodiment, the shelving arrangement 1 includes a backing board 9 that may be attached to a supporting structure such as a wall, or may be configured as a free standing display. FIG. 5 shows a perspective view of a power rail assembly 16 coupled to a backing board 9. The power rails 2a and 2b each include a flange portion 13 that sits in a complementary recess 22 in a rear surface of the backing board 9. The flange portion 13 may also include preformed holes 23 such as that shown in FIG. 6 for allowing fasteners (not shown) such as screws or bolts to extend through to fasten the power rail assembly 16 to the backing board 9.

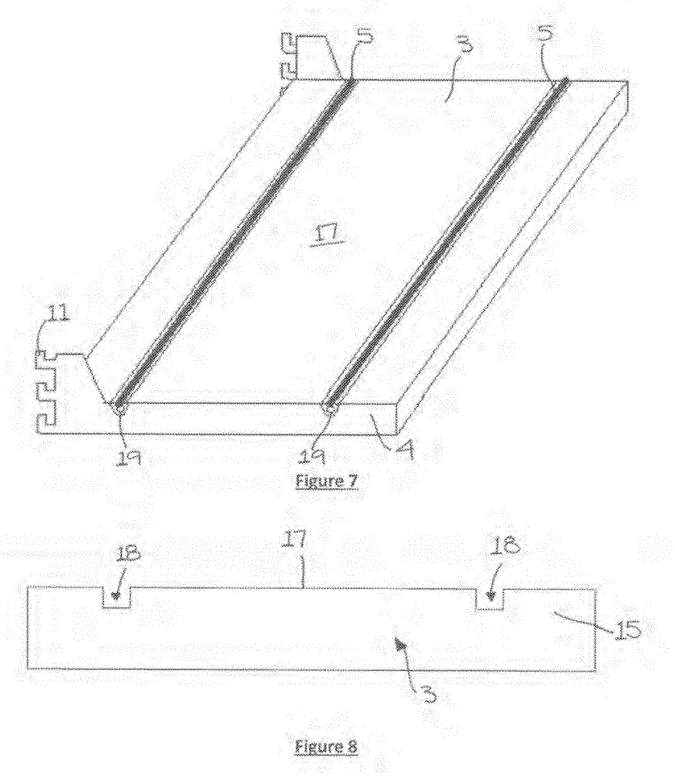

FIG. 7 shows an illustrative embodiment of a shelf board 3 and its extension arms 4 in an assembled form sitting upside down. The extension arms 4 are metal brackets that are electrically conductive. The brackets can be coupled to opposing sides of a shelf board 3 by any suitable means such as mechanical fasteners or adhesive. Lighting units 5 are disposed on the surface of, or embedded in, the shelf board 3 at desirable locations. Preferably, the lighting units 5 are disposed at a lower surface 17 of each shelf board 5 to illuminate the merchandise that is positioned in a space below these lighting units 5. The lighting units 5 can also be provided at other desirable locations, as long as they can receive electrical power from the extension arms 4.

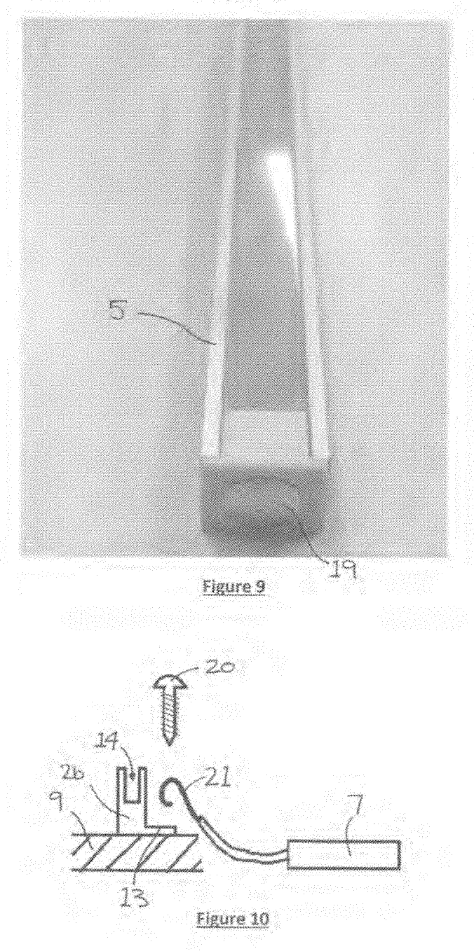

In the embodiment shown and with reference to FIG. 8, the shelf board 3 includes preformed channels 18 in the lower surface 17 for accepting one or more lighting units 5. The preformed channels 18 preferably extend the entire length of the shelf board 3 so that a portion of the extension arms 4 are exposed to the channels 18. In addition, the lighting unit 5 can be a ‘click in’ type LED strip that has two metal end caps with spring loaded contacts 19 (see FIG. 9). Once the LED strip is pushed into a channel, the metal contacts 19 touch the extension arms 4 and electrical coupling is formed. This means installation of the lighting units 5 simply requires a user to push an LED strip into one preformed channel and no additional wiring is required. This allows lighting units 5 to be easily replaced.

In most embodiments, a power adaption device 7 (see FIG. 10) is also included to convert an AC power source to a suitable low voltage power supply before it is supplied to the power rails 2a, 2b. In one embodiment, the power adaption device 7 is a transformer that converts an AC power source to a 12V or a 24V DC power supply for operating the lighting units 5.

The power source can be electrically coupled to the rails via any suitable means and at any suitable location. For example, in FIG. 2, electrical power is tapped to the power rails 2a, 2b from a lower end of each rail. In a simplest form, the electrical contact between the power source and the power rails 2a, 2b may be made by connecting, with a bolt 20, a spliced wire 21 of the power adaption device 7 to a flange 13 of a power rail 2b, such as is shown illustratively in FIG. 10. A cover component 8 (e.g. a non-conductive kicker board) can be included to conceal the wiring 6 from the power adaption device 7 to the rails and provide aesthetic appeal for the finished shelving arrangement 1, as shown in FIG. 1.

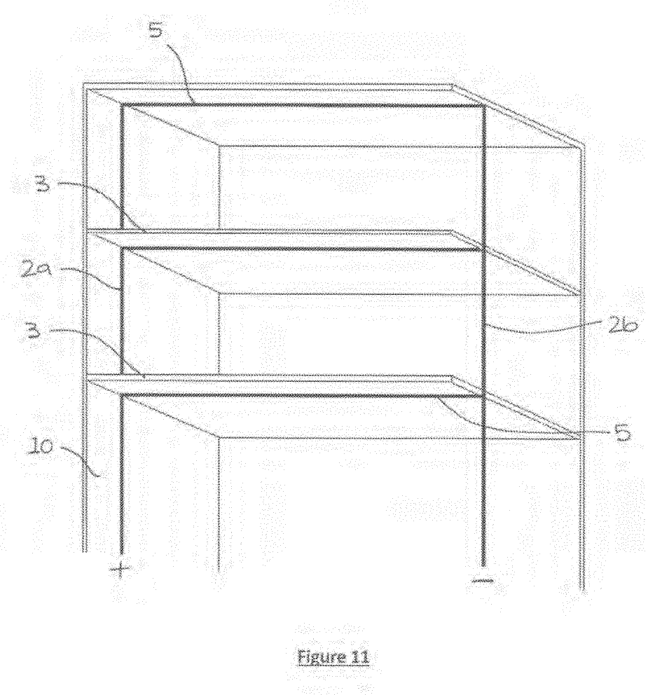

It will be appreciated that a shelving arrangement 1 can have its power rails 2a, 2b at other locations such as that shown in FIG. 11. FIG. 11 illustrates kitchen, wardrobe or bathroom cabinetry. In this embodiment the rails run up the side walls of the cabinets. The extension arms 4 may be completely eliminated and the lighting units 5 directly receive electrical power from a left and a right power rail 2a, 2b.

It will be appreciated that the powered shelving arrangement 1 may be utilised to power electrical components other than lighting units, for example digital photo frames, speakers, LED displays and so on.

It will be also appreciated that the shelving arrangement 1 according to the present invention is scalable to have any number of power rails and shelf boards 3 depending on the practical requirement and is not limited to what is illustrated in the exemplary embodiments described herein.

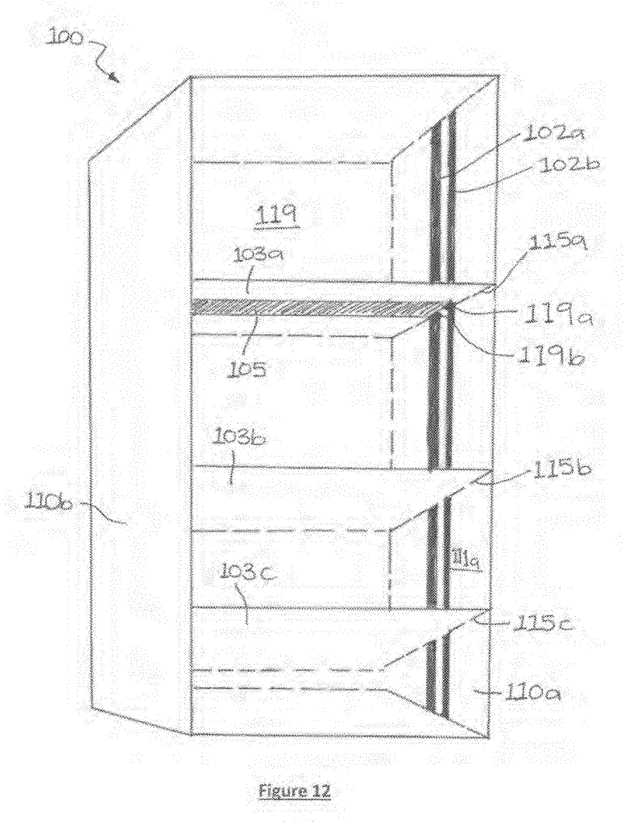

Another embodiment of an aspect of the present invention is shown in FIG. 12 by way of a vertically arranged furniture structure 100. The furniture structure 100 is shown as a vertical free-standing cabinet in this illustration but it will be appreciated that the furniture structure can be provided in other forms such as a single display, a cupboard, or similar. The illustrated furniture structure 100 includes a pair of vertical side panels 110a and 110b, a rear panel 119 and a plurality of shelf boards 103a, 103b, 103c extending in a generally horizontal direction between the side panels 110a and 110b to form shelves. The side panels 110a, 110b and the plurality of shelf boards 103a, 103b, 103c may be coupled together using any suitable mechanical fastening means, as will be appreciated by a person skilled in the art.

In accordance with the invention, the furniture structure 100 includes a pair of electrical conductors 102a, 102b. The electrical conductors 102a and 102b are both coupled to one side panel 110a and arranged to provide electrical power to an electrical component 105 of the furniture structure 100. The electrical component 105 includes two power terminals 119a, 119b at one end. The electrical component 105 is mechanically coupled to one of the shelf boards, e.g. 103a, wherein the electrical power that is required to operate the electrical component 105 is supplied by way of forming a direct physical and electrical contact between the power terminals 119a, 119b and the electrical conductors 102a, 102b. Each electrical conductor 102a, 102b is arranged to form a physical and electrical contact with a respective power terminal 119a or 119b of the electrical component 105. The plurality of shelf boards 103a, 103b, 103c are arranged such that their side surfaces 115a, 115b, 115c abut the inner surface 111a of the side panel 110a to ensure a proper physical and electrical contact can be established between the power terminals 119a, 119b of the electrical component 105 and the electrical conductors 102a, 102b.

FIG. 13 shows more details of the electrical conductors 102a and 102b. For ease of illustration, only a single side panel 110a and a single shelf board 103a are included in the figure. As shown, two electrical conductors 102a, 102b are each arranged to be electrically coupled to a differing polarity of a main power source 120. Differing polarity means a positive and a negative power connection, or a positive and a ground power connection. This means that the electrical conductors 102a and 102b are arranged on one side of the furniture structure 100 only, to simplify the manufacturing and installation process of the furniture structure 100.

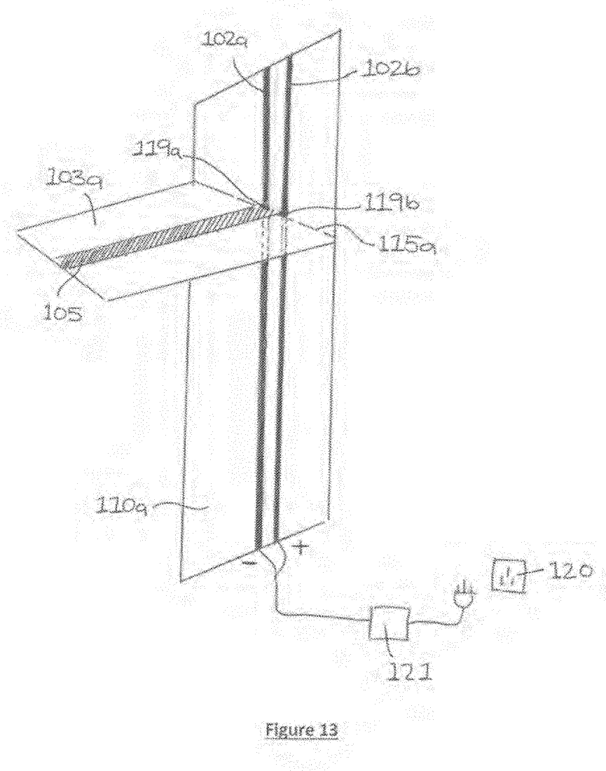

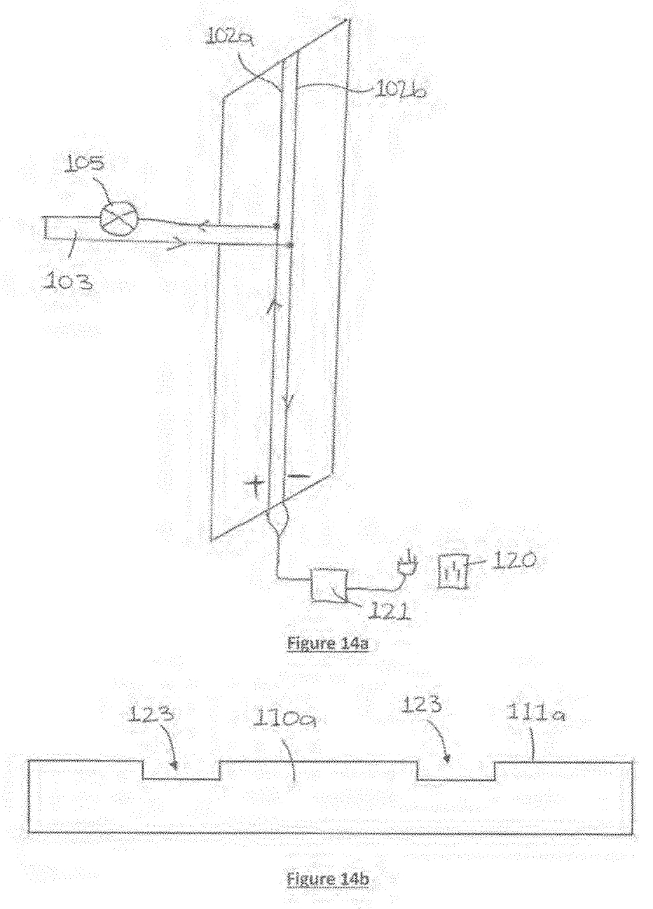

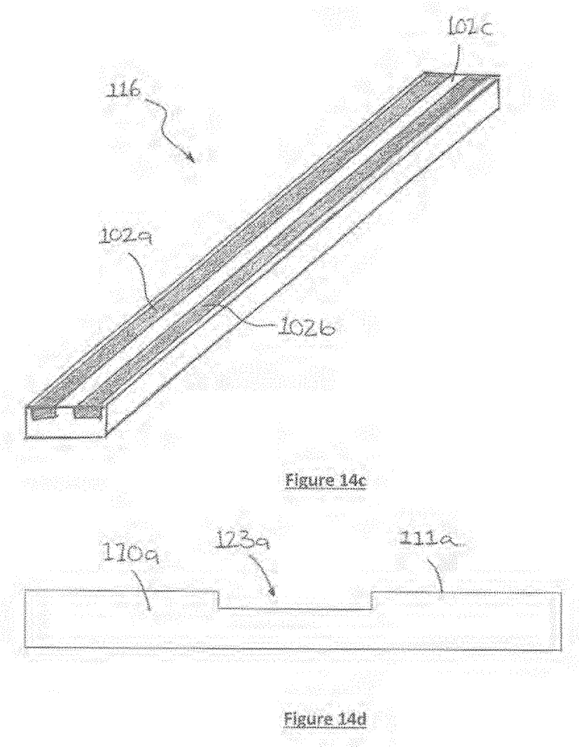

FIG. 14a shows a circuit diagram that illustrates the direction of the electrical power flow within the furniture structure 100. The electrical power required to operate the electrical component 105 flows from the main power source 120 via the power adaption device 121 to the electrical conductors 102a, 102b, and then to the power terminals 119a, 119b of the electrical component 105. As the electrical conductors 102a, 102b are arranged to be in physical contact with the respective power terminals 119a, 119b of the electrical component 105, and both electrical conductors 102a, 102b and power terminals 119a, 119b are made of a conductive material, electrical power can flow across the mechanical joint freely to operate the electrical component 105. It will be appreciated that the two electrical conductors 102a, 102b can provide a plurality of power tap off points along the length of the electrical conductors, which allows a shelf board to be positioned at any suitable height level. It also allows the furniture structure 100 to include a plurality of such electrical components 105.

Preferably, the electrical conductors 102a, 102b are fastened to the surface 111a of side panel 110a by any suitable mechanical fastening means. In one form, the side panel 110a may include preformed recesses or profiled channels to receive the electrical conductors 102a, 102b. FIG. 14b shows a cross-sectional top view of the side panel 110a along its width. It includes two preformed channels 123 in the surface 111a. In one form, the electrical conductors 102a, 102b are thin metal strips. The electrical conductors may be provided in alternative forms as a skilled person would appreciate.

In an alternative embodiment, the electrical conductors 102a, 102b may form part of a modular power rail assembly 116 such as that shown in FIG. 14c. The power rail assembly 116 also includes an insulation layer 102c physically joining and electrically separating the electrical conductors 102a and 102b. In this embodiment, a single preformed channel 123a is required in a side surface 111a of the side panel 110a to receive the power rail assembly 116 (such as that shown in FIG. 14d). Providing the electrical conductors 102a and 102b in a modular power rail assembly 116 may help to simplify the manufacturing and installation processes even further.

In yet another embodiment, the electrical conductors 202a and 202b may be provided as part of a flexible conductive tape 216 such as that shown in FIG. 15. The conductive tape 216 includes a non-conductive substrate material 253, wherein the pair of conductors 202a, 202b is provided on a top surface 225 of the substrate material 253. The conductive tape 216 can also include an adhesive means provided on the bottom surface of the substrate material 287 for easy coupling to the side surface of the side panel 210a. The flexible conductive tape 216 may be provided with a predetermined length, or it may be provided as a roll of continuous tape such as that shown in FIG. 15 and an end user can decide the length of tape required and cut a section from the roll provided.

As the furniture structure only requires electrical conductors 202a and 202b on one side panel 210a to provide the electrical power required to operate the electrical component 205, the manufacturing and installation of the overall furniture structure is greatly simplified. In addition, as an electrical circuit is formed by establishing a direct physical contact between the conductive components of the furniture structure 210, no additional cabling work is required to electrically couple the electrical component 205 to the electrical conductors 202a, 202b. This means that mechanical installation of the furniture structure also establishes the essential electrical connection that is required to allow power to flow to the electrical component 205. One would appreciate that the electrical conductors and the electrical component are located at predetermined locations in the furniture structure, to ensure that the conductive components are in proper physical and electrical contact once the shelf boards are installed.

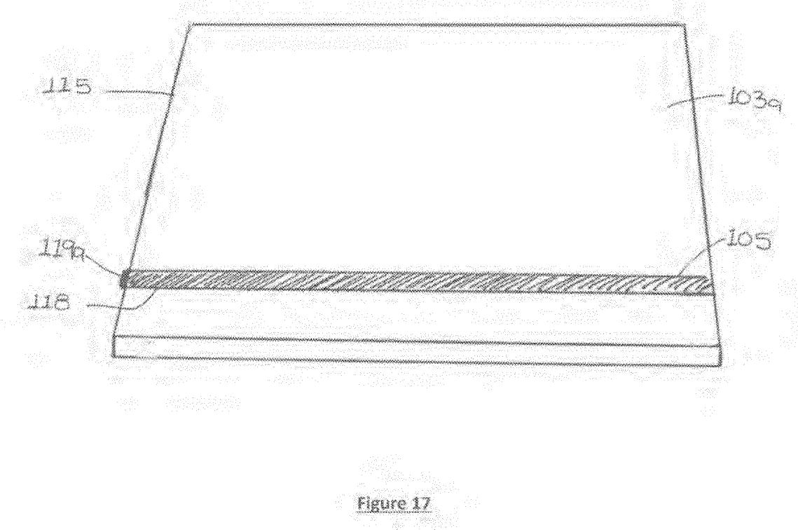

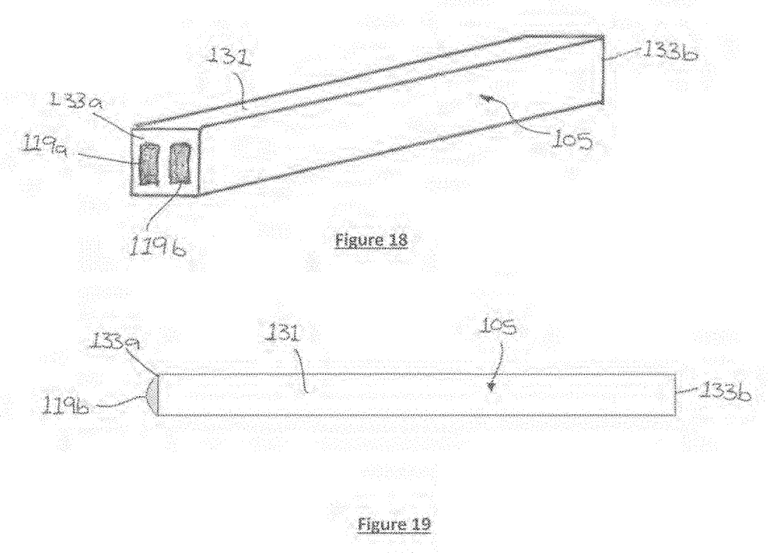

In the embodiments illustrated in FIGS. 12 through 16, the electrical component 105 is an illumination device that provides lighting for the furniture structure 100 at a desirable location. The illumination device may be disposed on the surface of, or embedded in, the shelf board 103a at any desirable location. FIGS. 17 and 18 show an illustrative embodiment of a shelf board 103a and an electrical component 105 respectively. With reference to FIG. 17, which is a bottom perspective view of shelf board 103a, a preformed channel 118 is provided in the lower surface of the shelf board for accepting the illumination device 105.

In addition, the illumination device 105 can be a ‘click in’ type LED strip that has two metal end caps 119a, 119b which act as the power terminals such as that shown in FIGS. 18 and 19. The LED strip includes an elongate body portion 131a and two opposing ends 133a, 133b, wherein the metal end caps 119a, 119b are located at one end 133a of the elongate body portion 131. The metal end caps may be equipped with spring loaded contacts. Once the LED strip is pushed into the preformed channel 118, the metal contacts 119a, 119b abut the electrical conductors 202a, 202b and electrical coupling is formed. This means installation of the illumination device 105 simply requires a user to push an LED strip into the preformed channel 118 of a shelf board and no additional wiring is required. This also allows the illumination device or other similar electrical components to be easily replaced if required.

In addition, to ensure that a proper and stable electrical connection can be made between the power terminals and the electrical conductors, the power terminals 119a, 119b slightly protrude, or bulge from the end 133a of the illumination device 105. More preferably, the power terminals are also arranged to slightly protrude or bulge from the side surface of the shelf board 103a such as that shown in FIG. 17. This ensures that after the shelf board 103a and the illumination device 105 are installed, the power terminals 119a, 119b can be slightly biased against the electrical conductors 202a and 202b, to maintain a tight physical contact between the electrically conductive elements of the furniture structure 100.

In the embodiments shown, the LED strip 105 is arranged to extend the entire width or at least a substantial width of the shelf board. However, it will be appreciated that the LED strip can come in other forms and does not have to extend the entire width of the shelf board. As long as the power terminals of the LED strip are accessible from one side surface of the shelf board, electrical power will be able to flow across the mechanical joint from the power rail assembly to operate the LED strip. It will also be appreciated that the powered furniture structure can include other types of electrical components, and the present invention is not just limited to illumination devices, such as LEDs, for example digital photo frames, speakers, LED displays and so on.

A power adaption device may be required to provide both positive and negative power supply to the conductors. In one form, the power adaption device preferably also converts the main power supply to a suitable DC voltage level to power the electrical component. In one embodiment, the power adaption device is a transformer that converts an AC power source to a 12V or a 24V DC power supply for operating the electrical component.

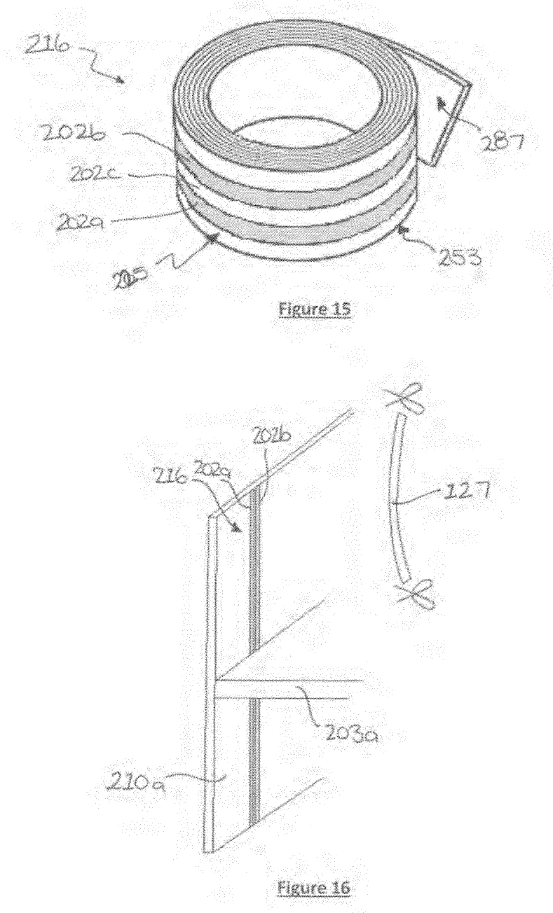

A cover component can be included to conceal the electrical conductors 102a, 102b to provide aesthetic appeal for the finished furniture structure 100 once all the components of the furniture structure are properly installed. The cover component can be a solid opaque cover that is slidable relative to the pair of conductors. In another embodiment, it can be a flexible tape 127 with a sticky backing such as that shown in FIG. 16. The flexible tape is cut into an appropriate dimension before being attached to the side panel to conceal the pair of conductors.

It will be also appreciated that the furniture structure according to the present invention is scalable to have any number of side panels and shelf boards depending on the practical requirement and is not limited to what is illustrated in the exemplary embodiments described herein.

It will be understood that the invention disclosed and defined in this specification extends to all alternative combinations of two or more of the individual features mentioned or evident from the text or drawings. All of these different combinations constitute various alternative aspects of the invention.

1. A furniture structure including:
one or more generally vertical side panels;
one or more shelf boards configured to extend from the one or more side panels;
two electrical conductors coupled to a side panel of the furniture structure, to receive electrical power of differing polarity from a power supply;
an electrical component coupled to a shelf board, wherein said electrical component includes two power terminals located at one end of the electrical component, the power terminals being accessible from a side surface of the shelf board; and
wherein the electrical power is supplied to the electrical component via a direct physical contact between the power terminals of the electrical component and the two electrical conductors.

2. A furniture structure according to claim 1, wherein the electrical conductors are a pair of thin metal strips coupled to a side surface of the side panel from which the shelf board extends.

3. A furniture structure according to claim 1, wherein the electrical conductors form part of a power rail assembly, the power rail assembly including a non-conductive insulation layer electrically separating the two electrical conductors.

4. A furniture structure according to claim 1, wherein the electrical conductors are provided as part of a flexible conductive tape comprising a non-conductive substrate material, wherein the pair of conductors is attached to or integrated into to the substrate material.

5. A furniture structure according to claim 4, wherein the conductive tape includes an adhesive means provided on one surface for coupling to a surface of the side panel.

6. A furniture structure according to claim 1, wherein the electrical component is an elongate lighting component that extends along the width of the shelf board, the lighting component including an elongate body portion and two opposing ends, wherein the two power terminals are located at one end of the elongate body portion and extend outwardly from a side surface of the shelf board after the lighting component is coupled to the shelf board.

7. A furniture structure according to claim 1, wherein the power terminals are provided in the form of two spaced-apart metal caps that protrude from the side surface of the shelf board so that the power terminals are biased against the electrical conductors once the shelf board including the lighting component is installed relative to the side panels(s).

8. A powered shelving arrangement comprising:
a pair of electrical conductors configured to be coupled to a generally vertical side panel of a supporting structure, wherein said electrical conductors are each configured to receive electrical power of differing polarity from a power supply;
at least one shelf board configured to extend from the generally vertical side panel;
an electrical component coupled to the shelf board and configured to receive the electrical power from the pair of electrical conductors, wherein said electrical component includes two power terminals located at one end of the electrical component, the power terminals being accessible from a side surface of the shelf board; and
the electrical power is supplied to the electrical component via a physical contact between the power terminals of the electrical component and the pair of electrical conductors.

9. A powered shelving arrangement according to claim 8, wherein the two electrical conductors are arranged side by side but separated apart by a parallel distance to avoid short circuiting between the electrical conductors.

10. (canceled)

11. (canceled)

12. A powered shelving arrangement comprising:
at least two spaced apart electrically conductive power rails, wherein each power rail in a pair is configured to receive electrical power of differing or opposing polarity;
one or more shelf boards supported by the power rails, wherein at least one of the one or more shelf boards includes a pair of electrically conductive extension arms for coupling to the power rails; and
one or more electrical components, wherein said coupling between the extension arms and the power rails allows electrical power to flow across the power rails and the extension arms to power the electrical components.

13. A powered shelving arrangement according to claim 12, wherein each power rail is part of a power rail assembly that includes two electrically conductive rails with an insulating layer physically joining and thermally separating the rails, the two rails each being configured to connect to an electrical power supply of differing or opposing polarity.

14. A powered shelving arrangement according to claim 12, wherein the extension arms are metal brackets that run adjacent the opposing side surfaces of a shelf board and include engagement portions for coupling to the power rails.

15. (canceled)
